(19) United States
(12) Patent Application Publication
(10) Pub. No.: US 2004/0092193 A1
(43) Pub. Date: May 13, 2004

(54) Method of manufacturing spark plug

(76) Inventors: Mamoru Musasa, Aichi (JP); Kiyohiro Kondo, Aichi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/467,712

(22) PCT Filed: Feb. 12, 2002
(86) PCT No.: PCT/JP02/01141

(30) Foreign Application Priority Data
Feb. 13, 2001 (JP) 2001-035716

(51) Int. Cl. H01T 21/02

(52) U.S. Cl. 445/7

(57) ABSTRACT

A linear noble-metal member 32′, which is formed of a noble metal or noble metal alloy and will become a spark portion 32, is positioned on a distal end portion 4a (an attachment portion) of a ground electrode 4 of a spark plug work 100′; the positioned linear noble-metal member 32′ is fixed to the distal end portion 4a by resistance welding or laser welding; and the fixed linear noble-metal member 32′ is cut.

### TECHNICAL FIELD

The present invention relates to a method for manufacturing a spark plug.

### BACKGROUND ART

In recent years, in order to enhance spark erosion resistance, ignition of an internal combustion engine has been provided by a type of spark plug in which a noble metal chip containing a predominant amount of Pt, It, or the like is welded to a distal end of a center electrode. Also, in recent years, in order to cope with exhaust gas regulations and the trend of an engine moving toward lean burn, enhanced ignition performance has been required of a spark plug, leading to the practice of reducing the diameter of a center electrode.

However, a reduction in the diameter of a center electrode is accompanied by the tendency for spark discharge between the center electrode and a ground electrode to occur at a specific position; consequently, in some cases, the ground electrode is markedly eroded. Hence, a spark discharge gap formed between the ground electrode and the center electrode increases, resulting in a failure to sufficiently yield the effect of lowering discharge voltage through a reduction in the diameter of the center electrode. In order to cope with the problem, in formation of a spark portion, a noble metal chip is attached to not only the center electrode but also the ground electrode, whereby the spark erosion resistance of the ground electrode is enhanced so as to suppress an increase in the spark discharge gap. When a noble metal chip is to be formed on the ground electrode as mentioned above, in order to reduce the amount of overhang of the ground electrode over the center electrode, Japanese Patent Application Laid-Open (kokai) Nos. S61-45583 and H07-37676 disclose a spark plug in which the noble metal chip is formed on a distal end portion of the ground electrode.

In a certain racing spark plug, the distal end of a center electrode is located within the interior of a metallic shell assuming a tubular shape. In such a spark plug, in order to form a spark discharge gap between a noble metal chip and the center electrode, the noble metal chip is attached to an edge portion of an opening of the metallic shell located on the side toward the spark discharge gap, such that a distal end portion of the noble metal chip protrudes into the opening.

When, as mentioned above, a noble metal chip is to be fixedly attached to the ground electrode or metallic shell so as to serve as a spark portion, according to a conventional practice, a noble metal material is subjected to plastic working such as blanking or cutting so as to be formed into a noble metal chip in a predetermined shape; the thus-formed noble metal chip is positioned at a predetermined position on the ground electrode or metallic shell; and the noble metal chip is fixed by means of resistance welding, laser welding, or the like.

However, in the above described method for fixedly attaching a noble metal chip to the ground electrode or metallic shell, first, a noble metal material is machined to a noble metal chip of a small size, thereby involving difficulty in positioning the noble metal chip on an attachment portion of a spark plug work to which the noble metal chip is to be fixedly attached. Also, the accuracy of positioning at the predetermined position is not sufficient, resulting in impaired productivity. Furthermore, man-hours required for forming a spark portion increase, resulting in a tendency toward increased cost; and much time is consumed in disposing a machined noble metal chip at a predetermined attachment position while the chip is being held, leading to a reduction in production efficiency.

An object of the present invention is to provide a method for manufacturing a spark plug for efficiently manufacturing a spark plug in which a noble metal member is formed on a ground electrode or metallic shell.

### DISCLOSURE OF THE INVENTION

To achieve the above object, the present invention provides a method for manufacturing a spark plug comprising a center electrode, an insulator surrounding a diametral periphery of the center electrode, a metallic shell surrounding a diametral periphery of the insulator, and a spark portion disposed at a position facing the center electrode and forming a spark discharge gap between the same and the center electrode, the method being characterized in that:

a linear noble-metal member made of a noble metal or noble metal alloy and used to form the spark portion is positioned at an attachment portion of a spark plug work to which the spark portion is to be fixedly attached, and subsequently the linear noble-metal member is cut so as to form the spark portion.

According to the above configuration, when undergoing positioning on the attachment portion of a spark plug work, a noble metal member used to form the spark portion is not machined beforehand into a small-size piece such as a conventional chip, but is held in a linear shape (e.g., a wire having such a length as to allow at least two (preferably three) chips of the same shape to be cut off therefrom), which is relatively easy to handle. As compared with a noble metal in a chip shape, or a noble metal chip, a noble metal member in a linear shape, or a linear noble-metal member, is easy to hold and handle at the time of disposition on the attachment portion; thus, the linear noble-metal member is easily positioned. According to the method of the present invention, before a noble metal member is machined into the shape of a chip, the noble metal member is positioned on the attachment portion of a spark plug work, followed by cutting. Thus, a process of machining the noble metal member into the shape of a chip can be eliminated, whereby production cost can be reduced. Furthermore, according to the method, a series of processes of positioning and cutting the linear noble-metal member can be performed in a relatively continuous manner, whereby cycle time can be shortened, and thus the effect of enhancing production efficiency can be expected. Through manufacturing a spark plug by the method, the spark portion which faces the center electrode across the spark discharge gap is accurately positioned, thereby contributing to mass production of spark plugs with low variations in spark erosion resistance.

Furthermore, the method for manufacturing a spark plug of the present invention can be such that, before the linear noble-metal member is cut, position-determining fixing is performed for fixing a position of the linear noble-metal member determined through positioning with respect to the attachment portion. According to the configuration of the present invention, before the linear noble-metal member is cut, position-determining fixing is performed for fixing a determined position of the linear noble-metal member. Fixing the linear noble-metal member suppresses a dislocation of the linear noble-metal member at the time of cutting the linear noble-metal member. Specifically, the position-determining fixing can be performed by means of resistance welding or laser welding.

Furthermore, the method for manufacturing a spark plug of the present invention can be such that the position-determining fixing also serves as a process of fixing the linear noble-metal member to the attachment portion in a final fixing condition (hereinafter referred to as “final fixing”). According to the configuration, after the linear noble-metal member is cut, the cut piece of the noble metal member does not need to undergo another fixing process in formation thereof into the spark portion. This feature is effective in terms of a reduction in processes. Notably, if positioning the linear noble-metal member also serves as position-determining fixing which, in turn, also serves as final fixing, the spark portion can be formed by merely cutting the linear noble-metal member which has undergone position-determining fixing. This feature is more effective in terms of a reduction in processes.

Also, the method of the present invention can be such that the position-determining fixing is not a process of fixing the linear noble-metal member to the attachment portion in a final fixing condition (final fixing), but a process of fixing the linear noble-metal member to the attachment portion in a temporary fixing condition (hereinafter referred to as “temporary fixing”); and, after temporary fixing, the linear noble-metal member is laser-welded to the attachment portion for final fixing. In the present configuration, the linear noble-metal member is fixedly attached to the attachment portion of a spark plug work through two processes; i.e., through temporary fixing and final fixing. Through employment of the configuration, the linear noble-metal member can be fixedly attached in a more reliable condition, thereby preventing dropping off of the spark portion or a like problem.

Notably, temporary fixing is performed by means of resistance welding, and final fixing is performed by means of laser welding. Fixing by means of resistance welding is advantageous in terms of cost and process simplicity. However, in some cases, fixing by means of only resistance welding may fail to provide sufficient fusion between the linear noble-metal member and the attachment portion of a spark plug work, potentially involving the following problem: as a result of a spark plug mounted on an engine being subjected to repeated operation, cracking or separation arises in the joint therebetween, and thus the spark portion formed of the linear noble-metal member comes off from the attachment portion. In order to cope with the problem, the method for manufacturing a spark plug of the present invention may be such that the linear noble-metal member is first fixed to the attachment portion in a temporary fixing condition by means of resistance welding, and is subsequently fixed in a final fixing condition by means of laser welding. Laser welding provides sufficient fusion in the joint, thereby preventing dropping off of the spark portion or a like problem. Since temporary fixing is performed by means of resistance welding before final fixing is performed by means of laser welding, the noble metal member is not dislocated at the time of laser welding. Therefore, laser welding does not require a special device or the like for fixing the noble metal member and is thus facilitated.

Furthermore, preferably, in the method for manufacturing a spark plug of the present invention, an unnecessary portion of the linear noble-metal member is cut and removed before final fixing is performed by means of laser welding. When the noble metal member is to be fixedly attached to the attachment portion of a spark plug work by means of laser welding, in some cases, an unnecessary portion of the linear noble-metal member present on the attachment portion may be obstructive to laser welding. Therefore, by cutting an unnecessary portion of the linear noble-metal member before final fixing is performed by means of laser welding, the obstructive portion of linear noble-metal member can be removed before laser welding, whereby enhancement of productivity can be expected.

In this case, so long as the linear noble-metal member is in a cut condition before final fixing is performed by means of laser welding, temporary fixing by means of resistance welding may be performed before or after the linear noble-metal member is cut.

The method for manufacturing a spark plug of the present invention can be applied to a spark plug having a ground electrode. In this case, the present invention can be such that:

the spark plug work comprises a ground electrode on which the spark portion for forming the spark discharge gap between the same and the center electrode is formed; and

a distal end portion of the ground electrode—whose rear end portion is joined to the metallic shell—for forming the spark discharge gap serves as the attachment portion, and the linear noble-metal member is positioned on the attachment portion. In manufacture of a spark plug having a ground electrode, as mentioned above, a distal end portion of the ground electrode for forming the spark discharge gap between the same and the center electrode serves as the attachment portion, and the noble metal member is positioned on the attachment portion. More specifically, when a distal end portion of the ground electrode is to serve as the attachment portion, the linear noble-metal member may be positioned on a side surface of the distal end portion which is to face a distal end surface of the center electrode, or the linear noble-metal member may be positioned on a distal end surface of the ground electrode. In this case, the position and orientation of the linear noble-metal member must be determined in the course of positioning such that good spark discharge is obtained at the spark portion on the ground electrode which faces the center electrode across the spark discharge gap.

A certain racing spark plug does not have a ground electrode, but is configured such that a noble metal member is fixedly attached to a metallic shell so as to serve as a spark portion for forming a spark discharge gap between the same and a center electrode held in the metallic shell. The present invention can also be applied to a method for manufacturing such a spark plug. Specifically, in this case,

the spark plug work is configured such that the spark portion for forming the spark discharge gap between the same and the center electrode is formed on the metallic shell, and an opening is formed on the metallic shell to be located on a side where the spark discharge gap is formed; and

an edge portion of the opening of the metallic shell serves as the attachment portion, and the linear noble-metal portion is fixedly attached to the attachment portion. In this case, the linear noble-metal member must be positioned such that the spark discharge gap is formed between the center electrode and the spark portion formed as a result of the linear noble-metal member being cut.

### BRIEF DESCRIPTION OF DRAWINGS

FIG. 1 is a front partial sectional view showing an example of a spark plug obtained by a manufacturing method of the present invention.

FIG. 2A is an explanatory view showing a first example of a process for forming a spark portion on a ground electrode.

FIG. 2B is an explanatory view continued from FIG. 2A.

FIG. 2C is an explanatory view continued from FIG. 2B.

FIG. 2D is an explanatory view continued from FIG. 2C.

FIG. 2E is an explanatory view continued from FIG. 2D.

FIG. 2F is an explanatory view continued from FIG. 2E.

FIG. 3A is an enlarged schematic view showing the spark portion formed by the process of FIG. 2.

FIG. 3B is a more enlarged schematic view showing the spark portion formed by the process of FIG. 2.

FIG. 4A is an explanatory view showing a second example of a process for forming a spark portion on a ground electrode.

FIG. 4B is an explanatory view continued from FIG. 4A.

FIG. 4C is an explanatory view continued from FIG. 4B.

FIG. 5A is an explanatory view showing an example, different from that of FIG. 2, of a process for forming a spark portion on a ground electrode.

FIG. 5B is an explanatory view continued from FIG. 5A.

FIG. 5C is an explanatory view continued from FIG. 5B.

FIG. 5D is an explanatory view showing a third example of a process for forming a spark portion on a ground electrode.

FIG. 5E is an explanatory view continued from FIG. 5D.

FIG. 6A is an explanatory view showing an example of a process for forming a spark portion on a metallic shell.

FIG. 6B is an explanatory view continued from FIG. 6A.

FIG. 6C is an explanatory view continued from FIG. 6B.

FIG. 6D is an explanatory view continued from FIG. 6C.

FIG. 6E is an explanatory view continued from FIG. 6D.

FIG. 6F is an explanatory view continued from FIG. 6E.

FIG. 7A is a schematic view showing a first example of a linear noble-metal member usable in the present invention.

FIG. 7B is a schematic view showing a second example of a linear noble-metal member usable in the present invention.

FIG. 7C is a schematic view showing a third example of a linear noble-metal member usable in the present invention.

FIG. 7D is a schematic view showing a fourth example of a linear noble-metal member usable in the present invention.

FIG. 8A is an explanatory view showing a process for forming a linear noble-metal member into a flat spark portion by means of resistance welding.

FIG. 8B is an explanatory view continued from FIG. 8A.

FIG. 8C is an explanatory view continued from FIG. 8B.

### BEST MODE FOR CARRYING OUT THE INVENTION

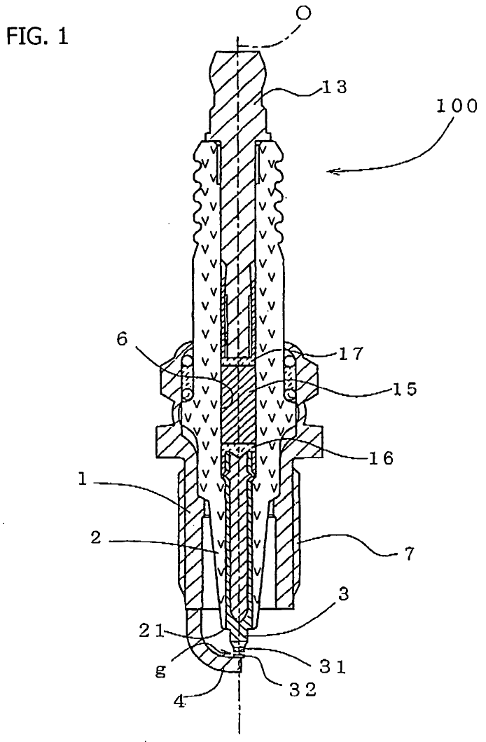

The best mode for carrying out the invention will next be described with reference to the drawings. FIG. 1 is a longitudinal sectional view showing an example of a spark plug 100 obtained by a manufacturing method of the present invention. The spark plug 100 includes a tubular metallic shell 1; an insulator 2, which is fitted into the metallic shell 1 such that a distal end portion 21 protrudes from the metallic shell 1; a center electrode 3, which is provided in the insulator 2 such that a spark portion 31 formed at a distal end thereof protrudes from the insulator 2; and a ground electrode 4, one end of which is joined to the metallic shell 1 by means of welding or the like and the other end portion of which is bent sideways such that a side surface thereof faces the spark portion 31 of the center electrode 3. A spark portion 32 is formed on the ground electrode 4 in such a manner as to face the spark portion 31, thereby forming a spark discharge gap g between the spark portions 31 and 32. The spark portion 32 is fixedly attached such that one end thereof protrudes from the distal end of the ground electrode 4.

The insulator 2 is formed of a ceramic sintered body such as alumina or aluminum nitride, and has a through-hole 6 formed therein along its axial direction and adapted to receive the center electrode 3. The metallic shell 1 is formed into a cylindrical shape from a metal such as low-carbon steel; serves as a housing of the spark plug 100; and has a male-threaded portion 7 formed on its outer circumferential surface and adapted to mount the plug 100 to an unillustrated engine block. A metallic terminal member 13 is fixedly inserted into one end portion of the through-hole 6, whereas the center electrode 3 is fixedly inserted into the other end portion of the through-hole 6. A resistor 15 is disposed within the through-hole 6 between the metallic terminal member 13 and the center electrode 3. Opposite end portions of the resistor 15 are electrically connected to the center electrode 3 and the metallic terminal member 13 via conductive glass seal layers 16 and 17, respectively.

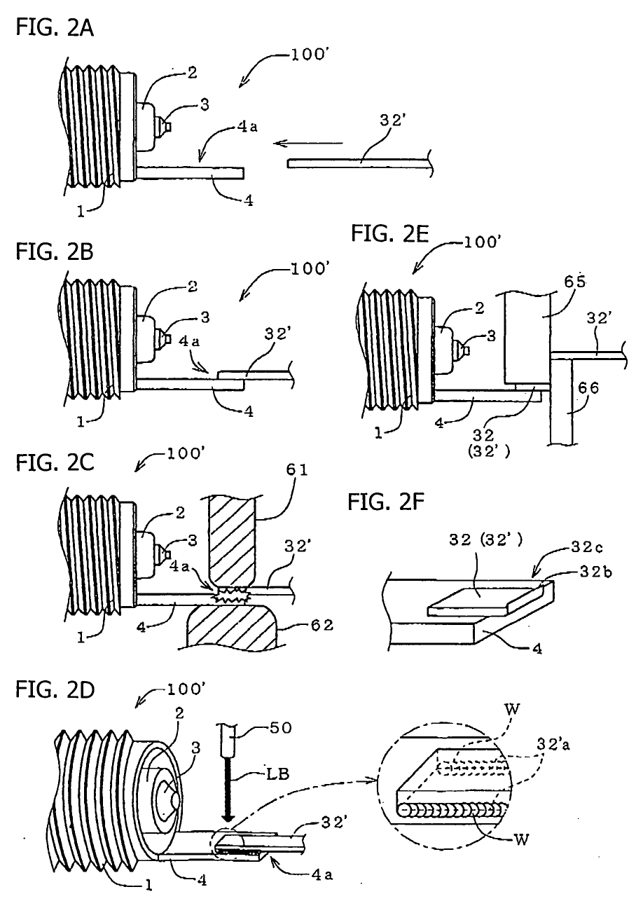

A method for manufacturing the above-described spark plug will next be described. Processes other than those related to requirements of the present invention are of a known method for manufacturing a spark plug, and thus detailed description thereof is omitted. FIGS. 2A-2F show an example of a process for forming the spark portion 32 of the spark plug 100 having the ground electrode 4. Here, there is used a spark plug work 100′ having a ground electrode 4 whose rear end portion is welded to a metallic shell 1, and a distal end portion 4a of the ground electrode 4 is used as an attachment portion. First, as shown in FIG. 2A, a linear noble-metal member 32′ is supplied to the distal end portion 4a. As shown in FIG. 2B, the linear noble-metal member 32′ is positioned on the distal end portion 4a. At this time, the ground electrode 4 assumes a straight shape; i.e., the ground electrode 4 is in a stage before undergoing bending such that the distal end portion 4a faces the center electrode 3.

In the present embodiment, after positioning is performed as described above, welding is performed for position-determining fixing. Specifically, position-determining fixing is performed by means of, for example, resistance welding. When position-determining fixing is to be formed by means of resistance welding, as shown in FIG. 2C, the distal end portion 4a of the ground electrode 4 and the linear noble-metal member 32′ are held in a fixedly sandwiched condition between welding electrodes 61 and 62, and subsequently electricity is applied to the welding electrodes 61 and 62 so as to heat the welding electrodes 61 and 62, thereby welding the linear noble-metal member 32′ and the distal end portion 4a of the ground electrode 4 together.

Alternatively, position-determining fixing may also be performed by means of laser welding. As shown in FIG. 2D, the linear noble-metal member 32′ positioned on the distal end portion 4a of the ground electrode 4 is irradiated with laser beam LB by use of a laser 50, thereby forming weld metal portions W each intruding into the linear noble-metal member 32′ and into the distal end portion 4a of the ground electrode 4. At this time, laser beam LB is radiated onto a portion of the linear noble-metal member 32′ serving as the spark portion 32 which does not contribute to discharge; for example, side portions 32a of the linear noble-metal member. By so doing, a central part of the spark portion 32 which is supposed to directly contribute to discharge is not irradiated with laser beam LB, whereby good spark discharge and spark erosion resistance are obtained.

After position-determining fixing is performed as described above so as to fix the linear noble-metal member 32′ to a spark plug work 100′ at a determined position, the linear noble-metal member 32′ is cut to a predetermined size, thereby forming the spark portion 32. At this time, as shown in FIG. 2E, while the linear noble-metal member 32′ is held firmly by means of a die 65 or the like, a cutting means 66 such as a cutter is caused to abut the linear noble-metal member 32′ from the ground electrode 4 side, and then a force is imposed on the cutting means 66 toward the linear noble-metal member 32′ from the ground electrode 4 side, thereby cutting the linear noble-metal member 32′. As a result of cutting from the direction, conceivably, a burr 32b or the like as shown in FIG. 2F is formed at an end part 32c of the spark portion 32. However, since the spark portion 32 is arranged such that the burr 32b formed thereon faces the center electrode 3, the electric field tends to be concentrated on the burr 32b, thereby yielding the effect of lowering discharge voltage. However, cutting by the cutting means 66 may be performed from the opposite direction (the direction toward the ground electrode 4 side from the linear noble-metal member 32′ side). Preferably, the linear noble-metal member 32′ is cut in such a manner as to slightly protrude from a distal end surface 4b of the ground electrode 4. Through such formation of the spark portion 32, the electric field tends to be concentrated on the end part 32c of the spark portion 32, whereby discharge voltage can be lowered.

Herein, the linear noble-metal member 32′ to be used has such a length as to allow at least two spark portions 32 to be cut off therefrom with respect to the longitudinal direction. A residual portion after cutting off one spark portion 32 is used for forming a spark portion of the next spark plug. When three or more spark plugs are to be continuously manufactured, the linear noble-metal member 32′ having a length corresponding to the number of spark plugs to be manufactured is prepared and repeatedly undergoes temporary fixing and cutting from the distal end side (this also applies to other embodiments to be described below).

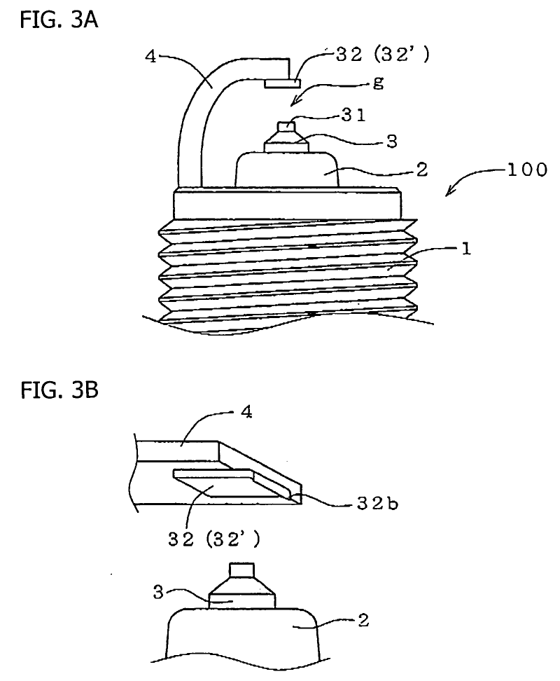

After the spark portion 32 is fixedly attached to the ground electrode 4 as described above, as shown in FIG. 3A, the ground electrode 4 is bent such that the spark portion 32 faces the center electrode 3 so as to form the spark discharge gap g between the spark portion 32 and the spark portion 31 of the center electrode 3. Preferably, in view of a decrease in discharge voltage, as shown in FIG. 3B, bending is performed such that the burr 32b of the spark portion 32 is located above the center electrode 3.

In the present embodiment, in order to secure high-temperature strength and corrosion resistance, a surface layer portion of a base metal of the ground electrode 4 is formed of a heat-resistant alloy which contains Ni or Fe as a main component. Particularly, an Ni-based heat-resistant alloy such as INCONEL600 (the trademark of a product from INCO Corp., UK) is preferred. Notably, herein, the term “main component” means a component whose content by weight is the highest. Also, the ground electrode 4 may assume such a composite structure that a core formed of a metal of good heat conduction, such as Cu, Ag, or an alloy which contains Cu as a main component, is embedded in an outer layer formed of a heat-resistant alloy which contains Ni or Fe as a main component and exhibits excellent high-temperature strength and corrosion resistance.

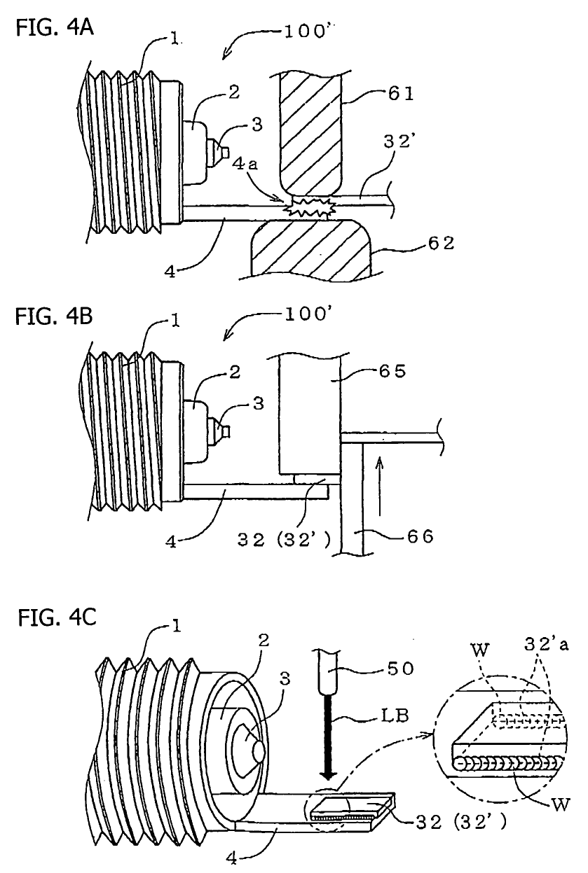

The spark portion 32 may be formed according to the process sequentially shown in FIGS. 4A-4C. First, the linear noble-metal member 32′ is positioned on the distal end portion 4a, or an attachment portion, of the ground electrode 4. Then, as shown in FIG. 4A, the distal end portion 4a of the ground electrode 4 and the linear noble-metal member 32′ are temporarily fixed together by means of resistance welding, which is performed by use of the welding electrodes 61 and 62. Subsequently, as shown in FIG. 4B, the linear noble-metal member 32′ is cut in a manner similar to that of FIG. 2E, thereby forming the spark portion 32. Finally, laser beam LB is radiated onto the linear noble-metal member 32′ which is in the cut condition (spark portion 32); specifically, onto the side surfaces 32a of the linear noble-metal member 32′ (spark portion 32), whereby the weld metal portions W are formed to thereby weld the side surfaces 32a and the ground electrode 4 together.

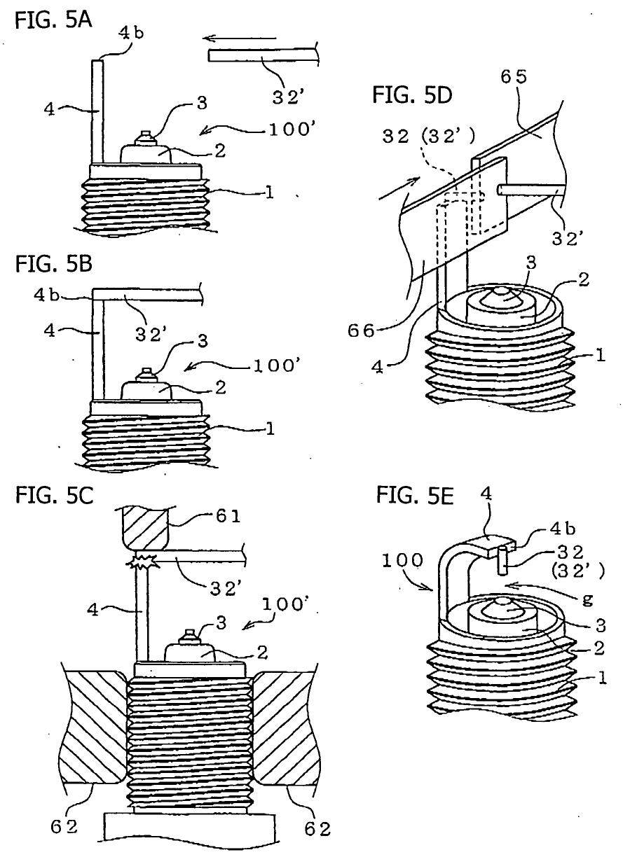

FIGS. 5A-5E explain a case where the distal end surface 4b of the ground electrode 4 serves as an attachment portion, and the linear noble-metal member 32′ is positioned on and then fixedly attached to the distal end surface 4b. First, as shown in FIG. 5A, the linear noble-metal member 32′ is supplied to the distal end surface 4b of the ground electrode 4. Then, as shown in FIG. 5B, the linear noble-metal member 32′ is positioned on the distal end surface 4b of the ground electrode 4. Subsequently, as shown in FIG. 5C, the positioned linear noble-metal member 32′ is fixed at the determined position by means of resistance welding, which is performed by use of the welding electrodes 61 and 62. In this case, welding cannot be performed as shown in FIG. 2C, in which, while the ground electrode 4 and the linear noble-metal member 32′ are held in a sandwiched condition between the welding electrodes 61 and 62, electricity is applied for welding. Thus, one welding electrode 61 is arranged such that the linear noble-metal member 32′ is caused to abut the distal end surface of the ground electrode 4, whereas the other welding electrode 62 is arranged in such a manner as to hold the outer circumferential surface of the metallic shell 1. Electricity is applied to the thus-arranged welding electrodes 61 and 62, thereby performing resistance welding. Notably, this process of position-determining fixing can be performed by means of laser welding.

Then, the linear noble-metal member 32′ which has undergone position-determining fixing as described above is cut as shown in FIG. 5D. The die 65 and the cutter 66 are caused to abut the linear noble-metal member 32′ such that the linear noble-metal member 32′ is held therebetween, and are then caused to cut the linear noble-metal member 32′ in a shearing manner. Notably, another known method may be used for cutting the linear noble-metal member 32′. The linear noble-metal member 32′ is thus cut, whereby the spark portion 32 is formed. The ground electrode 4 is bent such that the thus-formed spark portion 32 faces the center electrode 3, thereby yielding the spark plug 100 shown in FIG. 5E.

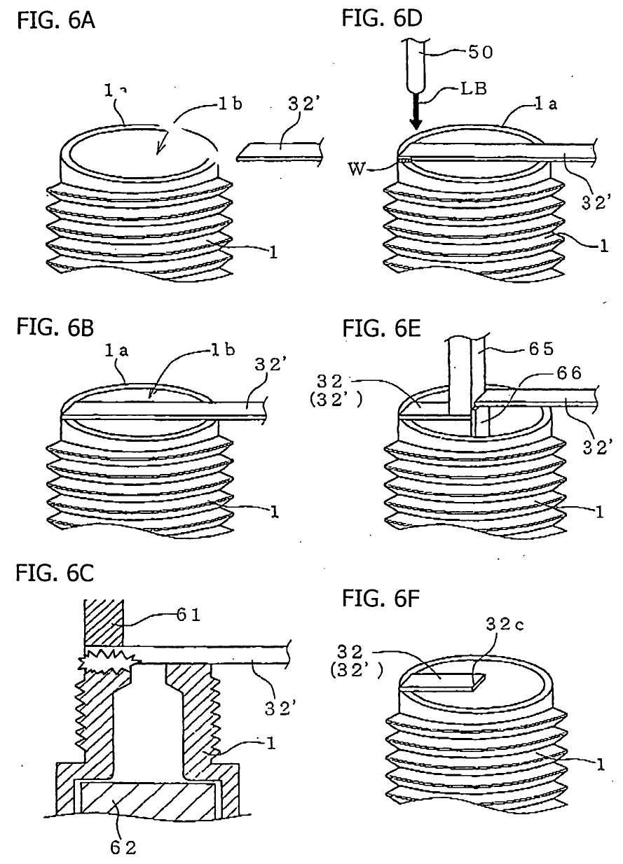

The method for manufacturing a spark plug having the ground electrode 4 has been described. However, the present invention can also be applied to a method for manufacturing a spark plug having no ground electrode; for example, a spark plug in which a noble metal member serving as the spark portion 32 is fixedly attached to the metallic shell 1 (mainly used as a racing spark plug). FIGS. 6A-6F explain a process for positioning the linear noble-metal member 32′ on and fixedly attaching to an opening edge portion 1a of the metallic shell 1 while the opening edge portion 1a serves as an attachment portion. As shown in FIG. 6A, the linear noble-metal member 321 is supplied to the metallic shell 1. Then, as shown in FIG. 6B, the linear noble-metal member 32′ is positioned on the opening edge portion 1a of the metallic shell 1. At this time, the linear noble-metal member 32′ is positioned in such a manner as to extend across an opening portion 1b of the metallic shell 1. Next, the linear noble-metal member 32′ is welded for position-determining fixing. At this time, as shown in FIG. 6C, the linear noble-metal member 32′ and the metallic shell 1 may be resistance-welded together by use of the welding electrodes 61 and 62. Alternatively, as shown in FIG. 6D, the linear noble-metal member 32′ and the opening edge portion 1a of the metallic shell 1 may be laser-welded together such that the weld metal portions W are formed through radiation of laser beam LB.

Next, the linear noble-metal member 32′ which has undergone position-determining fixing as shown in FIG. 6C or 6D is cut as shown in FIG. 6E. At this time, while a portion of the linear noble-metal member 32′ which will serve as the spark portion 32 is held firmly by means of the die 65, and the linear noble-metal member 32′ is cut by the cutting means 66 disposed within the metallic shell 1. The linear noble-metal member 32′ is thus cut, thereby forming the spark portion 32 as shown in FIG. 6F. At this time, the size of the spark portion 32 formed through cutting is adjusted such that the distal end part 32c of the spark portion 32 is held in the metallic shell 1 or faces a distal end portion of a center electrode (not shown in FIG. 6F) protruding from the opening portion 1b, so as to perform good spark discharge.

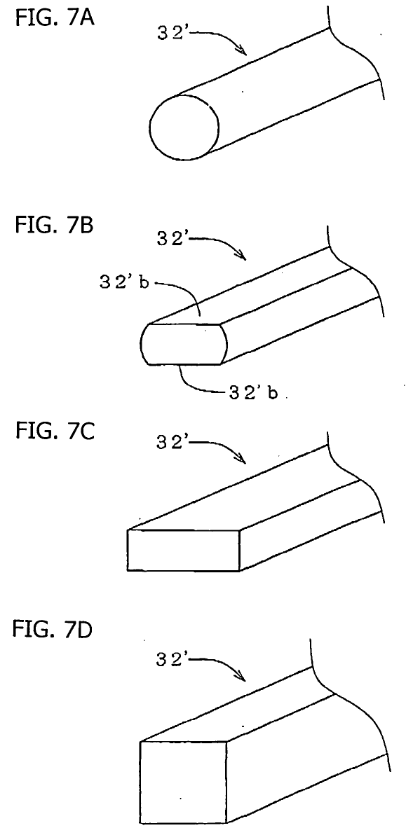

In the above-described methods, the linear noble-metal member 32′ to be used has at least one flat-surface portion on its outer surface, and the linear noble-metal member 32′ is positioned such that the flat-surface portion thereof faces, for example, an attachment portion of the ground electrode 4 or metallic shell 1 of the spark plug work 100′. This facilitates positioning and position-determining fixing of the linear noble-metal member 32′ on the attachment portion, whereby the effect of suppressing separation or the like of the welded linear noble-metal member 32′ can be expected. Furthermore, among the above-described linear noble-metal members 32′, for example, the linear noble-metal member 32′ that has a pair of flat-surface portions 32b formed on the outer surface thereof in opposition to each other with respect to the center axis thereof and in parallel with each other as shown in FIG. 7B is preferably used. Alternatively, there may be used the linear noble-metal member 32′ whose section taken perpendicularly to the center axis assumes a rectangular or square outline as shown in FIGS. 7C and 7D.

Also, there may be used the linear noble-metal member 32′ whose section taken perpendicularly to the center axis assumes a circular outline as shown in FIG. 7A. In the case of the linear noble-metal member 32′ for ordinary use, the linear noble-metal member 32′ whose section taken perpendicularly to the center axis assumes a circular outline is manufactured more easily than is the linear noble-metal member 32′ having the above-mentioned flat-surface portion(s). Therefore, from use of the linear noble-metal member 32′ having such a circular cross section, the effect of simplifying a process for forming the spark portion 32 can be expected.

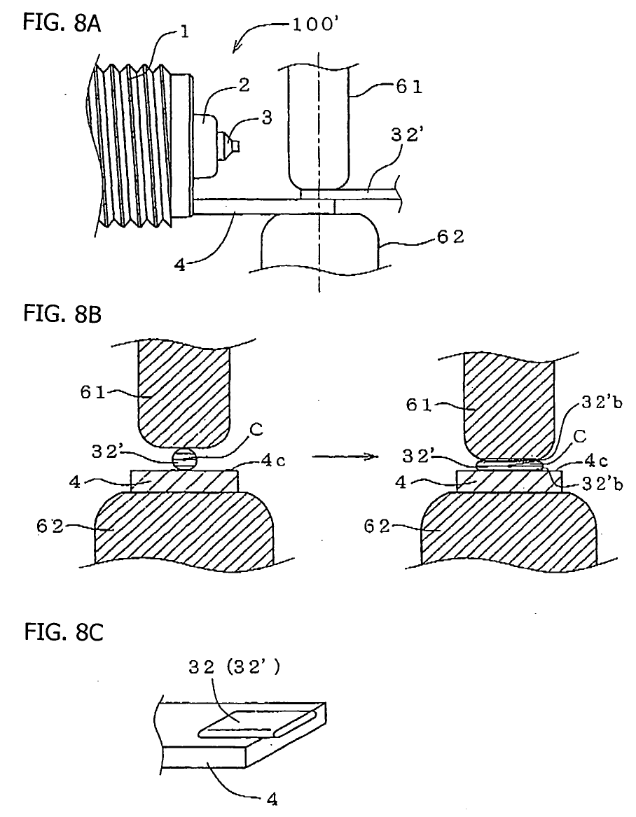

In the case of using the linear noble-metal member 32′ having such a circular cross section, as shown in FIGS. 8A-8C, the linear noble-metal member 32′ undergoes position-determining fixing by means of resistance welding so as to be fixed to an attachment portion of the ground electrode 4 at a determined position; and by means of the welding electrode 61 used in this resistance welding process, the linear noble-metal member 32′ is pressed against the attachment portion from a direction perpendicular to the surface of the attachment portion in contact with the linear noble-metal member 32′ so as to form the pair of flat-surface portions 32b on the linear noble-metal member 32′ in opposition to each other with respect to the center axis C of the linear noble-metal member 32′ and in parallel with each other, whereby the spark portion 32 in a flat shape can be formed. Specifically, when resistance welding is performed by use of the welding electrodes 61 and 62 as shown in FIG. 8A, the linear noble-metal member 32′ is pressed, by means of the welding electrode 61, against a side surface 4c (an attachment portion) of the ground electrode 4 from a direction perpendicular to the side surface 4c of the ground electrode 4 as shown in FIG. 8B. By so doing, the spark portion 32 in a flat shape is obtained as shown in FIG. 8C.

The linear noble-metal member 32′ used in the present invention can be such that one or more elements selected from the group consisting of Ir, Pt, Rh, Pd, Os, and W are contained. Use of the linear noble-metal member 32′ having such composition imparts good durability to the spark portion 32 to be formed from the linear noble-metal member 32′. Notably, an Ir-based alloy which contains Ir as a main component, or a Pt-based alloy which contains Pt as a main component is preferably used.

When the linear noble-metal member 32′ formed of a Pt-based alloy is used, resistance welding of the linear noble-metal member 32′ and an attachment portion formed of an Ni-based alloy provides sufficient joining strength, and thus in some cases final fixing by means of laser welding may not be required. Therefore, when the spark portion 32 is to be formed of a Pt-based alloy, in view of production cost and ease of manufacture, the method of the present invention in which fixing by means of resistance welding also serves as final fixing is preferred. However, in the case where the linear noble-metal member is formed of an Ir-based alloy, the following problem is involved. Since the difference in coefficient of linear expansion between Ir and an Ni-based alloy used to form the attachment portion is greater than that between Pt and an Ni-based alloy, fixing by means of only resistance welding fails to provide sufficient fusion in a joint between the linear noble-metal member and the attachment portion. As a result, in the course of use of the spark plug, thermal stress is induced by the difference in coefficient of linear expansion, potentially causing dropping off of the spark portion 32 or a like problem. Therefore, when the spark portion 32 is to be formed of an Ir-based alloy, the method of the present invention in which final fixing is performed by means of laser welding is particularly preferred. Notably, herein, the name of a metal element followed by the term “-based alloy” (e.g., Ir-based alloy) means that the content of the metal element (Ir) in the alloy is the highest.

1. A method for manufacturing a spark plug comprising a center electrode, an insulator surrounding a diametral periphery of the center electrode, a metallic shell surrounding a diametral periphery of the insulator, and a spark portion disposed at a position facing the center electrode and forming a spark discharge gap between the same and the center electrode, the method being characterized in that:
a linear noble-metal member made of a noble metal or noble metal alloy and used to form the spark portion is positioned at an attachment portion of a spark plug work to which the spark portion is to be fixedly attached, and subsequently the linear noble-metal member is cut so as to form the spark portion.

2. A method for manufacturing a spark plug as described in claim 1, wherein before the linear noble-metal member is cut, position-determining fixing is performed for fixing a position of the linear noble-metal member determined through positioning with respect to the attachment portion.

3. A method for manufacturing a spark plug as described in claim 2, wherein the position-determining fixing is performed by means of resistance welding.

4. A method for manufacturing a spark plug as described in claim 2, wherein the position-determining fixing is performed by means of laser welding.

5. A method for manufacturing a spark plug as described in any one of claims 2 to 4, wherein the position-determining fixing also serves as a process of fixing the linear noble-metal member to the attachment portion in a final fixing condition (hereinafter referred to as “final fixing”).

6. A method for manufacturing a spark plug as described in claim 2 or 3, wherein the position-determining fixing is not a process of fixing the linear noble-metal member to the attachment portion in a final fixing condition (final fixing), but a process of fixing the linear noble-metal member to the attachment portion in a temporary fixing condition (hereinafter referred to as “temporary fixing”); and, after temporary fixing, the linear noble-metal member is laser-welded to the attachment portion for final fixing.

7. A method for manufacturing a spark plug as described in claim 6, wherein an unnecessary portion of the linear noble-metal member is cut and removed before final fixing is performed by means of laser welding.

8. A method for manufacturing a spark plug as described in any one of claims 1 to 7, wherein the spark plug work comprises a ground electrode on which the spark portion for forming the spark discharge gap between the same and the center electrode is formed; and
a distal end portion of the ground electrode-whose rear end portion is joined to the metallic shell for forming the spark discharge gap serves as the attachment portion, and the linear noble-metal member is positioned on the attachment portion.

9. A method for manufacturing a spark plug as described in claim 8, wherein the linear noble-metal member is positioned on a side surface of the distal end portion of the ground electrode which is to face a distal end surface of the center electrode.

10. A method for manufacturing a spark plug as described in claim 8, wherein the linear noble-metal member is positioned on a distal end surface of the ground electrode.

11. A method for manufacturing a spark plug as described in any one of claims 1 to 7, wherein the spark plug work is configured such that the spark portion for forming the spark discharge gap between the same and the center electrode is formed on the metallic shell, and an opening is formed on the metallic shell to be located on a side where the spark discharge gap is formed; and
an edge portion of the opening of the metallic shell serves as the attachment portion, and the linear noble-metal portion is positioned on the attachment portion.

12. A method for manufacturing a spark plug as described in any one of claims 1 to 11, wherein the linear noble-metal member is such that at least one flat-surface portion is formed on an outer surface thereof; and the linear noble-metal member is positioned such that the flat-surface portion thereof faces the attachment portion.

13. A method for manufacturing a spark plug as described in claim 12, wherein the linear noble-metal member is such that a pair of the flat-surface portions is formed on the outer surface thereof in opposition to each other with respect to a center axis thereof and in parallel with each other.

14. A method for manufacturing a spark plug as described in any one of claims 1 to 11, wherein the linear noble-metal member is such that a section thereof taken perpendicularly to an axis thereof assumes a circular outline.

15. A method for manufacturing a spark plug as described in claim 14, wherein the position-determining fixing is performed by means of resistance welding; and, by means of a welding electrode used in the resistance welding process, the linear noble-metal member is pressed against the attachment portion from a direction perpendicular to a surface of the attachment portion so as to form a pair of flat-surface portions on the linear noble-metal member in opposition to each other with respect to a center axis of the linear noble-metal member and in parallel with each other, thereby forming a flat spark portion.

16. A method for manufacturing a spark plug as described in any one of claims 1 to 15, wherein the linear noble-metal member contains one or re elements selected from the group consisting of Ir, Pt, Rh, Pd, Os, and W.
